(19) United States
(12) Patent Application Publication
(10) Pub. No.: US 2018/0056461 A1
(43) Pub. Date: Mar. 1, 2018

(54) Logman

(71) Applicant: Leslie Gene Smith, Cut Blank, MT (US)

(72) Inventor: Leslie Gene Smith, Cut Blank, MT (US)

(21) Appl. No.: 15/603,963

(22) Filed: May 24, 2017

Related U.S. Application Data
(60) Provisional application No. 62/380,867, filed on Aug. 29, 2016.

(51) Int. Cl. B23Q 1/26; B27B 17/00; B27B 29/02; B23Q 16/00

(52) U.S. Cl. CPC B23Q 1/262; B23Q 16/001; B27B 29/02; B27B 17/0083

(57) ABSTRACT

A woodworking jig to hold lumber may include a central column; a chainsaw support assembly to slidably connected to the central column; an angle grinder support assembly to slidably connect to the central column; and a vertical log support to support the lumber positioned alongside of the central column.

### FIELD OF THE INVENTION

The present invention relates generally to a woodworking jig. More specifically, the present invention relates to an adjustable frame that holds a collection of woodworking tools in orientations that facilitate safely cutting and grinding pieces of wood

### BACKGROUND OF THE INVENTION

Woodworking is a trade that has been used throughout the ages. From carpentry to cabinet making, wood is used to make things that improve humanity's quality of life.

The tools used to craft objects out of wood have advanced as human technology advances. Tools such as power saws and power drills have dramatically improved the process of woodworking.

The present invention is a device that improves upon the field of woodworking equipment. By combining power tools with an adjustable jig, the Logman functions as a device which makes it easier for craftsmen to perform carpentry tasks. The present invention employs adjustable tool support assemblies to maintain chainsaws and angle grinders in positions that make it easier to perform a desired cut. More specifically, the Logman enables a user to cut logs to length, cut slabs of wood, and to cut different diameter tenons on log ends.

### BRIEF DESCRIPTION OF THE DRAWINGS

FIG. 1 is a front view of the Logman.

FIG. 2 is a rear view of the present invention.

FIG. 3 is a left-side view of the present invention.

FIG. 4 is a right-side view of the present invention.

FIG. 5 is a top view of the present invention.

FIG. 6 is a bottom view of 5 the present invention.

FIG. 7 is an isometric perspective view of the present invention.

FIG. 8 is a perspective view of the present invention.

FIG. 9 is a perspective view of the angle grinder support assembly.

FIG. 10 is a left-sideview of the chainsaw support assembly with the trigger actuator and cantilever tether removed.

FIG. 11 is a perspective view of the chainsaw support assembly with the trigger actuator and cantilever tether attached.

FIG. 12 is a perspective view of the chainsaw support assembly with the trigger actuator and cantilever tether attached.

FIG. 13 is a perspective view of the chainsaw support assembly with the trigger actuator and cantilever tether attached.

FIG. 14 is a perspective view of the chainsaw support assembly with the trigger actuator and cantilever tether attached.

FIG. 15 illustrates a perspective view of the adjustable chainsaw bar guide of the present invention.

FIG. 16 illustrates a perspective view of the vertical first cut locking tool guide of the present invention.

FIG. 17 illustrates a side view of the vertical first cut locking tool guide of the present invention.

FIG. 18 illustrates a perspective view of a post holder/tow receiver bracket of the present invention

FIG. 19 illustrates a top view of the adjustable pole support bracket of the present invention.

FIG. 20 illustrates a side view of the adjustable pole support bracket of the present invention.

FIG. 21 illustrates a perspective view of an adjustable log bottom support of the present invention.

FIG. 22 illustrates a perspective view of an adjustable rotational chainsaw bracket of the present invention;

FIG. 23 illustrates a side view of another embodiment of the present invention;

FIG. 24 illustrates a perspective view of another embodiment of the present invention;

FIG. 25 illustrates a top view of another embodiment of the present invention.

### DETAIL DESCRIPTIONS OF THE INVENTION

All illustrations of the drawings are for the purpose of describing selected versions of the present invention and are not intended to limit the scope of the present invention.

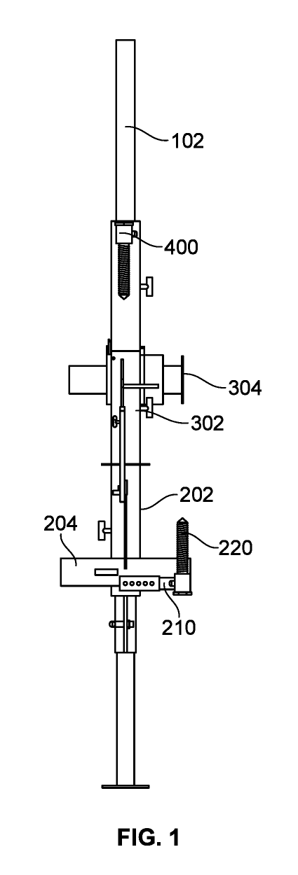

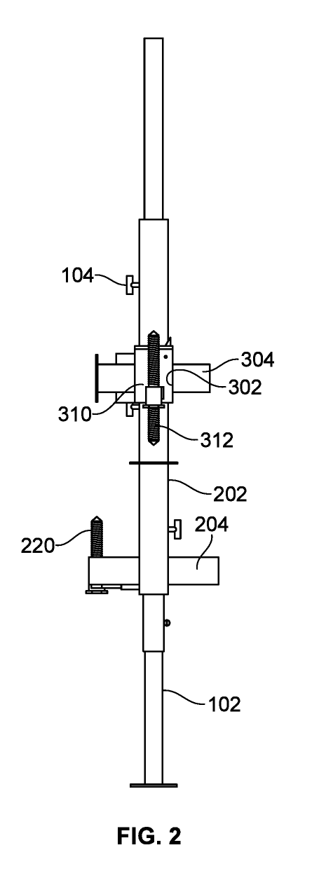

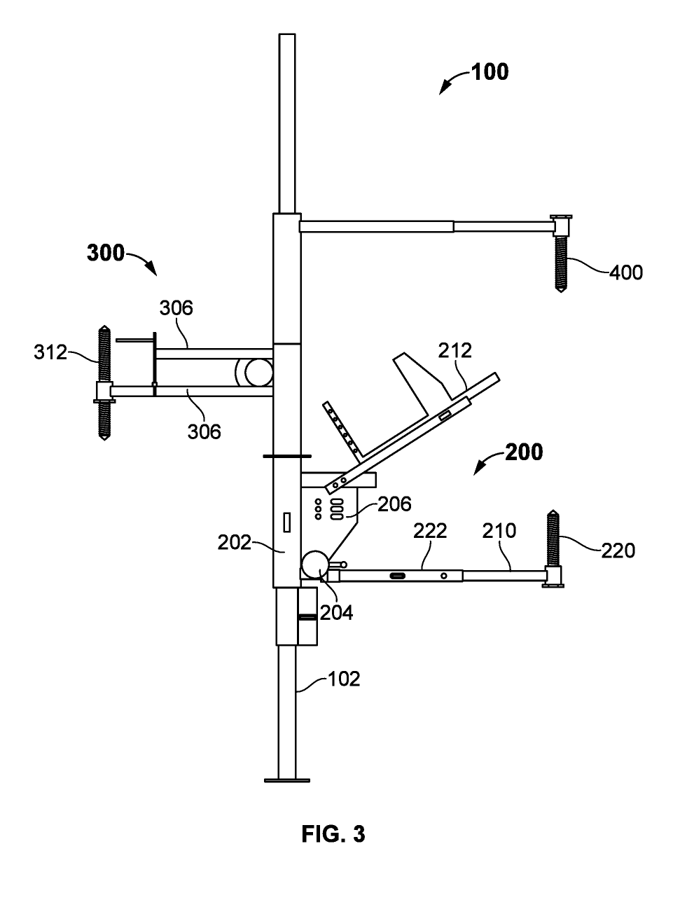

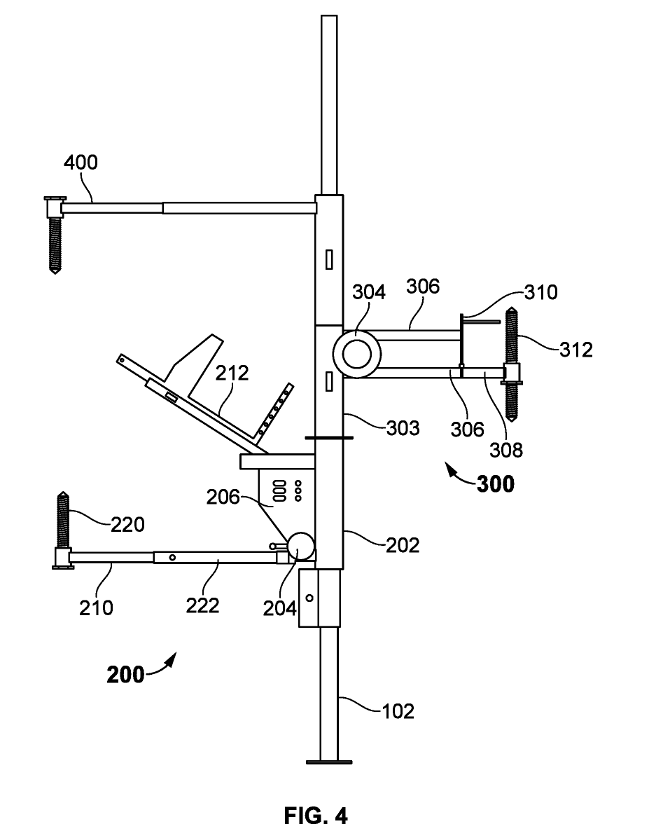

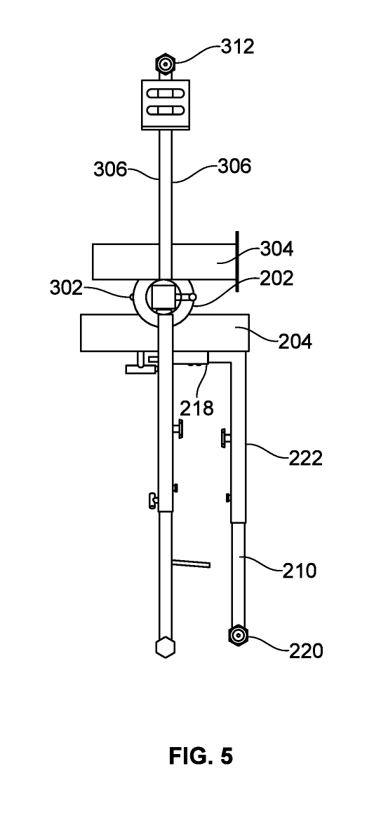

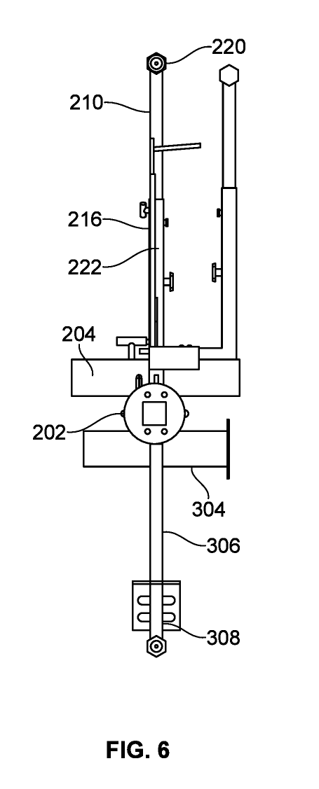

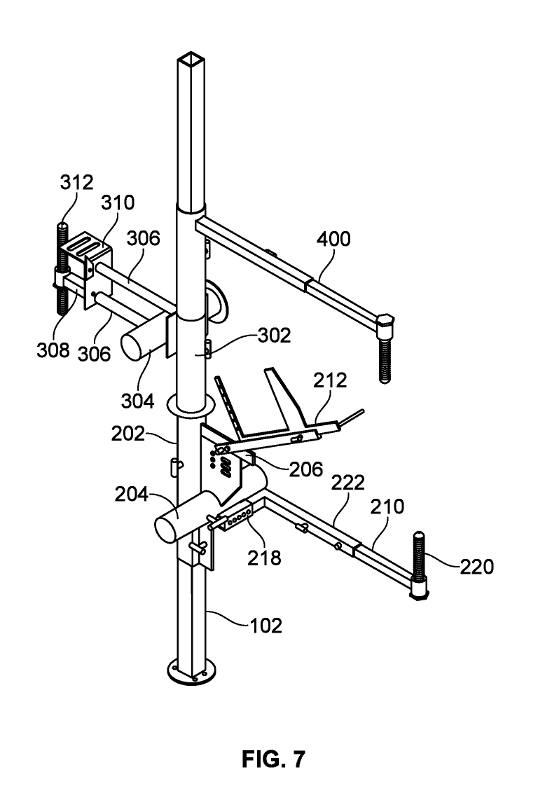

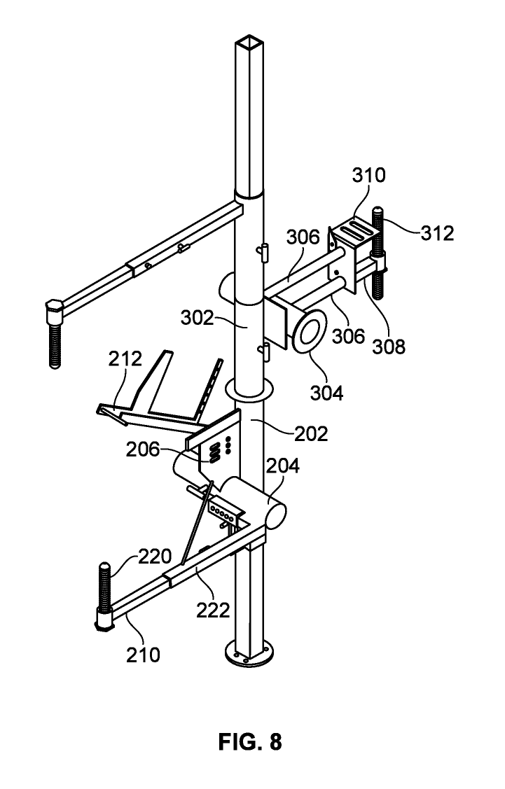

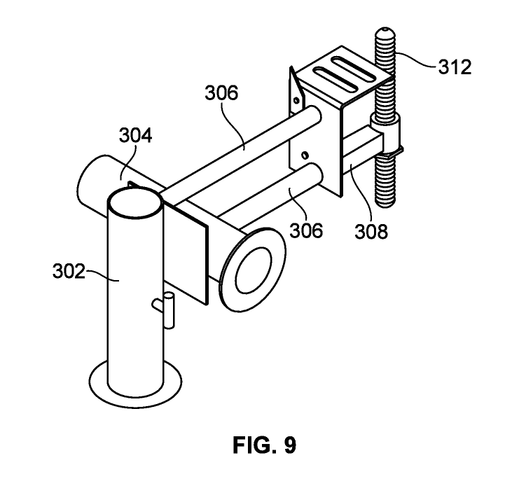

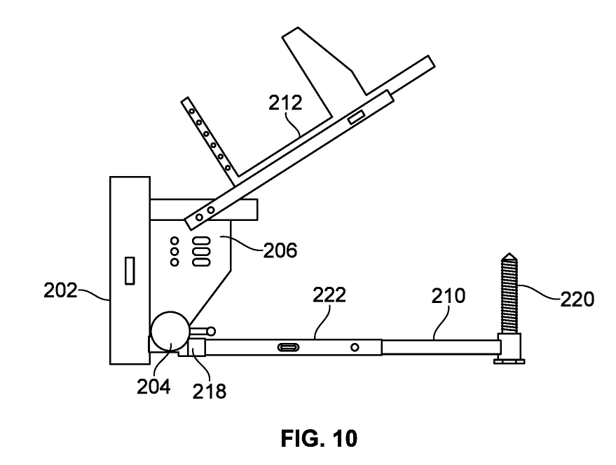

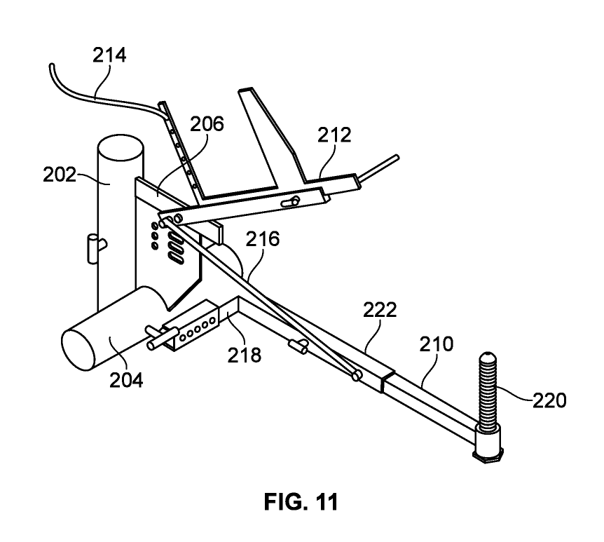

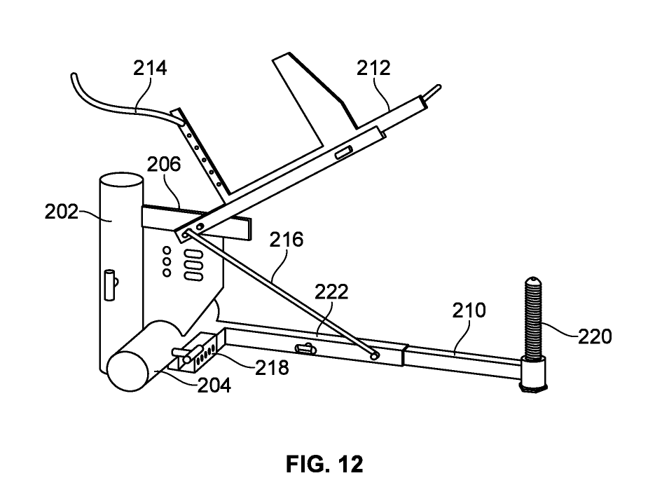

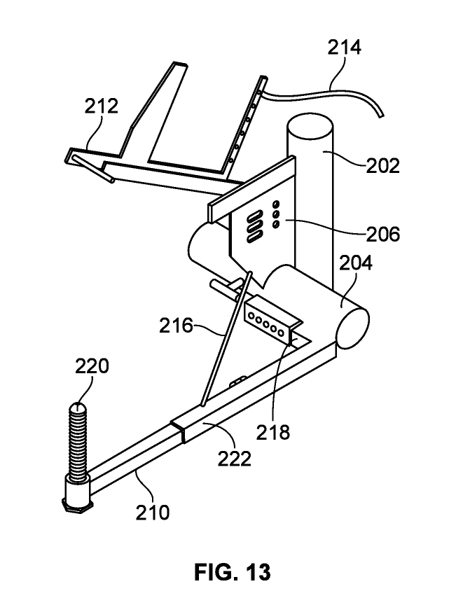

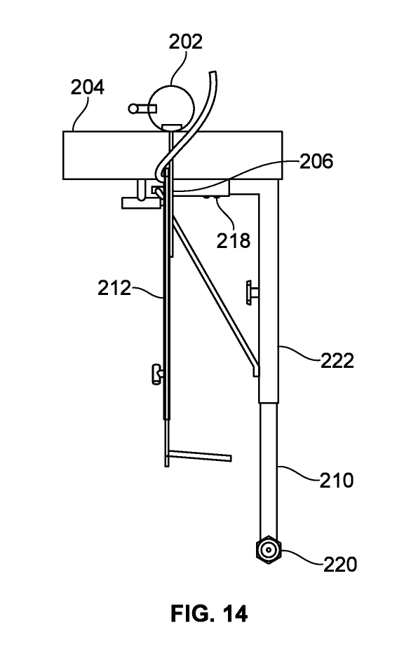

In reference to FIG. 1 through FIG. 14, the preferred embodiment of the present invention, the Logman, is a woodworking jig 100 designed to hold tools and pieces of lumber in orientations that facilitate carpentry tasks. The Logman comprises a central column 102, a sleeve clamp 104, a chainsaw support assembly 200, an angle grinder support assembly 300, and a vertical log support assembly 400. It is an aim of the present invention to provide an adjustable woodworking tool that is used to hold woodworking tools in positions which enable a craftsman to easily cut and shape pieces of wood. The Logman is designed to be an adjustable structure that enables a craftsman to slide the chainsaw support assembly 200, the angle grinder support assembly 300, and the vertical log support assembly 400 along the central column 102. By sliding these support assemblies along the central column, the craftsman is able to position any attached woodworking tools at desired locations. In addition to moving the support assemblies along the length of the central column, the craftsman is able to adjust the orientation of the attached woodworking tools. As a result, the craftsman is able to use the Logman to work pieces of wood with varying length, shape, and width.

In the preferred embodiment of the present invention, the central column 102 is a rigid pole that is mounted onto a working surface and functions as a rail along which the sleeve clamp 104, chainsaw support assembly 200, angle grinder support assembly 300, and vertical log assembly 400 slide. The sleeve clamp 104 is a device that slides along the central column 102 and can be locked into place at any position along the central column 102. It is an aim of the present invention to provide a sleeve clamp 104 that, once clamped onto the central column 102, supports the remaining components of the Logman. That is, the sleeve clamp 104 functions as a clamp style shaft collar and mechanical stop, preventing any attached components from sliding passed it along the central column. A craftsman is able to engage and disengage the sleeve clamp 104 at will. Consequently, the craftsman is able to maintain any connected support assemblies in desired positions.

In the preferred embodiment of the present invention, the chainsaw support assembly 200 is a component that is used to slidably mount a chainsaw onto the central column 102. The chainsaw support assembly 200 comprises a vertical chainsaw shaft collar 202, a horizontal chainsaw shaft collar 204, a chainsaw connection plate 206, a guide arm 208, and an adjustable-length cantilever 210. It is an aim of the present invention to provide a vertical chainsaw shaft collar 202 that is oriented perpendicularly to the horizontal chainsaw shaft collar 204. This configuration enables the chainsaw support assembly to maintain the blade of an attached chainsaw in a vertical orientation, perpendicular to the ground, while the vertical chainsaw shaft collar 202 is engaged around the central column 102. Conversely, the chainsaw support assembly is able to maintain the blade of an attached chainsaw in a horizontal orientation, parallel to the ground, while the horizontal chainsaw shaft collar 204 is engaged around the central column 102. Both the vertical chainsaw shaft collar 202 and the horizontal chainsaw shaft collar 204 are equipped with set screws that lock the devices in place, once engaged. Additionally, the vertical chainsaw shaft collar 202 and the horizontal chainsaw shaft collar 204 are able to rotate around the support column while attached. This enables the chainsaw support assembly 200 to connect to chainsaws of varying shape and size. Furthermore, the rotational functionality of the chainsaw support assembly 200 enables an attached chainsaw to cut slabs of wood out of a log.

In the preferred embodiment of the present invention, the chainsaw connection plate 206 is a rigid surface onto which a chainsaw is mounted. It is an aim of the present invention to provide a chainsaw connection plate 206 that is equipped with mechanical fasteners which enable a chainsaw to be detachably mounted onto the chainsaw support assembly 200. Embodiments of the Logman feature chainsaw connection plates 206 that use mechanical fasteners such as clamps, screws, latches, interlocking members, and the like. The chainsaw connection plate 206 extends from the vertical chainsaw shaft collar 202.

In the preferred embodiment of the present invention, the guide arm 208 is pivotably connected to the chainsaw support plate 206 that functions as a jig and is used to activate the blade of the attached chainsaw. The guide arm 208 comprises a trigger actuator 216, a cantilever tether 214, and an adjustable jig 218. It is an aim of the present invention to provide a trigger actuator 216 which is a flexible cable that extends from the guide arm 208 to the trigger 216 of the chainsaw. Mounted onto the chainsaw connection plate 206. As a user employs the adjustable jig 218 in a cutting task, the guide arm 208 pivots and causes the trigger actuator 216 to pull the trigger of the attached chainsaw. As a result, the guide arm 208 acts as a safety mechanism that prevents the blade of a chainsaw from activating, unless the craftsman is actively engaged in a cutting task. The cantilever tether 214 is an elastic band that provides the resistive force required to pivot the guide arm 208 away from the chainsaw blade and release the chainsaw's trigger, after a cutting task is completed. In the preferred embodiment of the present invention, the adjustable jig 218 is a bracket that enables the craftsman to perform precise and reproducible cutting tasks. The craftsman may reposition the adjustable jig 218 along the length of the guide arm 208 to accommodate various chainsaw blade sizes.

In the preferred embodiment of the present invention, the adjustable-length cantilever 210 is a device used to support a piece of wood being worked by the craftsman. The adjustable-length cantilever 210 is connected to the vertical chainsaw shaft collar 202 at one end. The adjustable length cantilever 210 comprises a saw log fastener 220 and a telescoping saw accommodation mechanism 222. The saw log fastener 220 is positioned at the end of the adjustable-length cantilever 210, opposite to the telescoping saw accommodation mechanism 222. A user is able to adjust the length of the cantilever 210 such that the saw log fastener 220 is able to hold a log at a desired position. The saw log fastener 220 is inserted into a piece of wood and functions as a mechanical fastener. It is an aim of the present invention to provide a saw log fastener 220 whose orientation can be adjusted to support a piece of wood parallel to or perpendicular to the central column. That is, the saw log fastener 220 can be rotated to facilitate cutting logs or creating tenons. The telescoping saw accommodation mechanism 222 is a telescoping tube that enables the adjustable-length cantilever 210 to be repositioned. The telescoping saw accommodation mechanism 222 is connected to the horizontal saw shaft collar 204 and enables a user to reposition the adjustable length cantilever 210. By repositioning the adjustable length cantilever 210 the user is able to accommodate saws of varying shape and size. This enables the user to cut tenons with a wide range of chainsaws.

In the preferred embodiment of the present invention, the angle grinder support assembly 300 is designed to maintain one or more connected angle grinders in a desired position while a craftsman performs a cutting task. The angle grinder support assembly 300 comprises a vertical grinder shaft collar 302, a horizontal grinder shaft collar 304, a grinder support beam 306, and an extending grinder boom 308. It is an aim of the present invention to provide a vertical grinder shaft collar 302 that is oriented perpendicularly to the horizontal grinder shaft collar 304. This configuration enables the angle grinder support assembly to maintain the blade of an attached angle grinder in a vertical orientation, perpendicular to the ground, while the vertical grinder shaft collar 302 is engaged around the central column.

Conversely, the angle grinder support assembly is able to maintain the blade of an attached angle grinder in a horizontal orientation, parallel to the ground, while the horizontal grinder shaft collar 304 is engaged around the central column. Both the vertical grinder shaft collar 302 and the horizontal grinder shaft collar 304 are equipped with set screws that lock the devices in place, once engaged. The vertical grinder shaft collar 302 and the horizontal grinder shaft collar 304 can be detached from the support column 102. This enables a user to bolt or clamp the angle grinder support assembly onto a workbench or table.

In the preferred embodiment of the present invention, the grinder support beam 306 extends from the vertical grinder shaft collar 302, and is a rigid structure into which an angle grinder can be mounted. It is an aim of the present invention to provide a grinder support beam 306 on which one or more angle grinders can be mounted. Embodiments of the present invention make use of mechanical fasteners to mount an angle grinder onto the grinder support beam 306. These mechanical fasteners can be clamps, latches, clasps, and the like. In a supplementary embodiment the angle grinder support beam 306 further comprises a dual angle grinder bracket 310. The dual angle grinder bracket 310 is used to mount a second angle grinder onto the grinder support beam 306. The extending grinder boom 308 is a device that is used to maintain a piece of wood in a desired location while the attached angle grinder removes unwanted portions of the wood. A first end of the extending grinder boom 308 is connected to the grinder support beam 306. A grinder log fastener 312 is connected to a second end of the extending grinder boom 308, opposite the grinder support beam. The grinder log fastener 312 is used to connect a piece of wood to the angle grinder support assembly. A craftsman is able to swivel the grinder log fastener 312 to facilitate grinding away sections of wood from both ends of a log. In the preferred embodiment of the present invention, the vertical log support assembly used to hang a log vertically so that a craftsman can cut it using the tools connected to the chainsaw support assembly and the angle grinder support assembly.

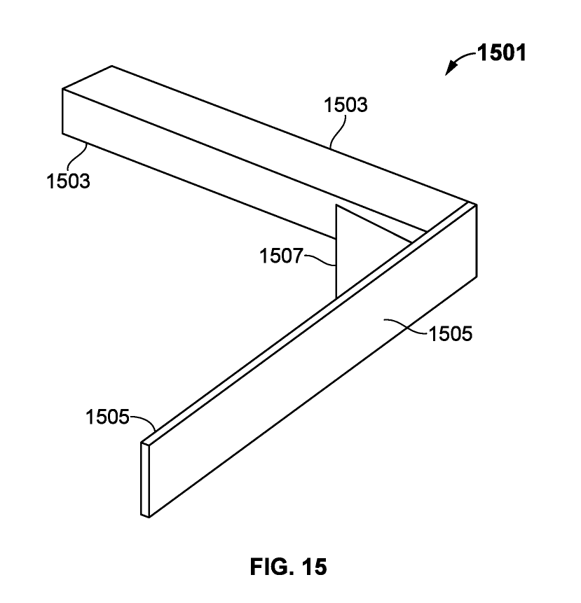

FIG. 15 illustrates an adjustable chainsaw bar guide 1501 which may be substantially L-shaped and may include a slide in tube 1503 which may be connected to a guide plate 1505 to guide the chainsaw and a gusset plate 1507 to connect the slide in tube 1503 to the guide plate 1505.

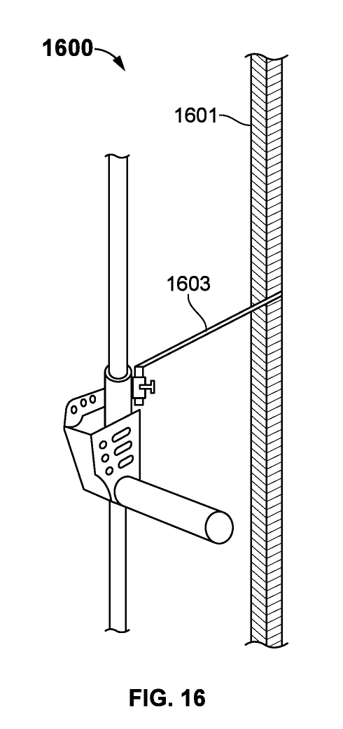

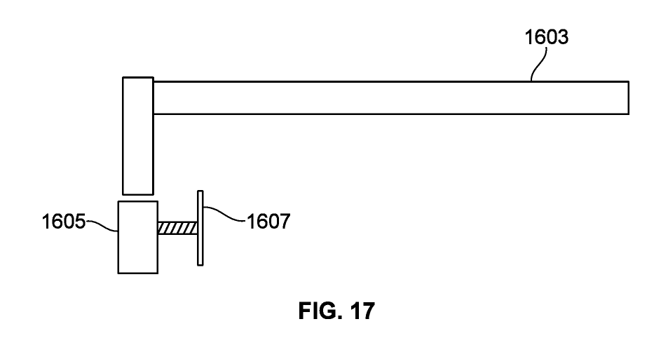

FIGS. 16 and 17 illustrate a vertical first cut locking tube guide 1600 which may include a vertical shaft 1601 which may be a wooden post and a horizontal arm 1603 which may engage the vertical shaft 601 to raise and lower the horizontal arm 1603. The horizontal arm 1603 may be L-shaped and engage a receiver tube 1605 which may be connected to the chainsaw bracket and the receiver tube 105 may include a fastener 1607 which may be a wing screw to engage the horizontal arm 1603.

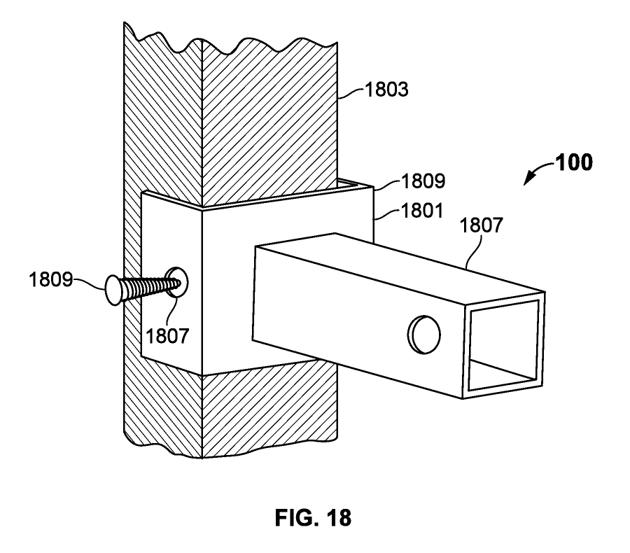

FIG. 18 illustrates the post holder to tow receiver bracket 1800 which may include a post holder section 1801 which may be substantially U-shaped to engage the post/vertical shaft 1803 and may include a pair of opposing apertures 1807 to accept fasteners 1809 which may be a wood screw to secure the post holder section 1801 to the vertical shaft 1803. The post holder section 101 is connected to a tow shaft section 1811 to connect to a vehicle.

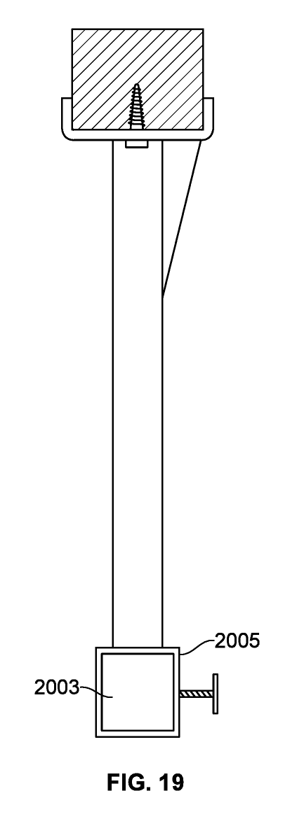

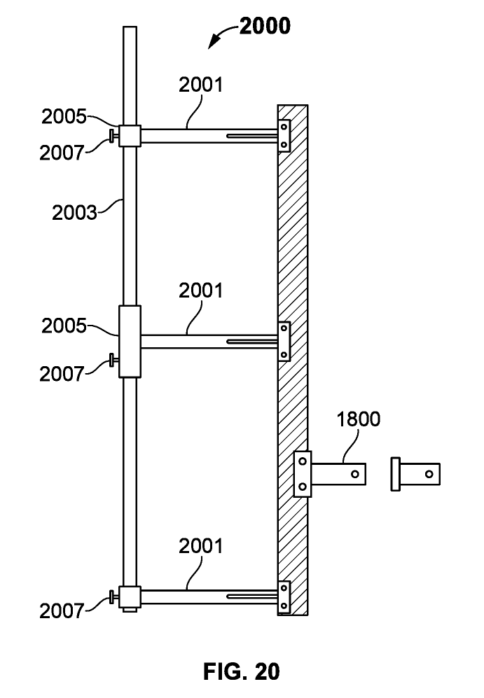

FIGS. 19 and 20 illustrate the adjustable pole support bracket 2000 which may include the post holder to tow receiver bracket 1800 and the vertical shaft 1803. In addition, a multitude of horizontal arms 2001 connect to a second vertical shaft 2003. The horizontal arms 2001 may connect between the vertical shaft 1803 and a second vertical shaft 2003. The horizontal arms 2001 may connect to a receiving connector 2005 which may be a hollow shaft in order to slidably connect to the second vertical shaft 2003. FIG. 19 illustrates a fastener 2007 which may fasten the receiving connector 2005 to the second vertical shaft 2003.

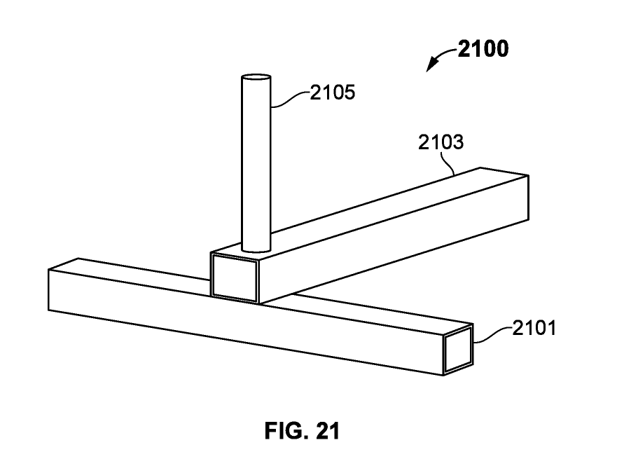

FIG. 21 illustrates another aspect of the present invention and illustrates a adjustable bottom support 2100 which may include a first arm 2101 and a second arm 2103 which may be a hollow rectangular shaft and may be positioned substantially perpendicular to the first arm 2101. A support shaft 2105 may be mounted on an end of the second arm 2103 to be positioned at the vertical center of the log support post (not shown in FIG. 21.

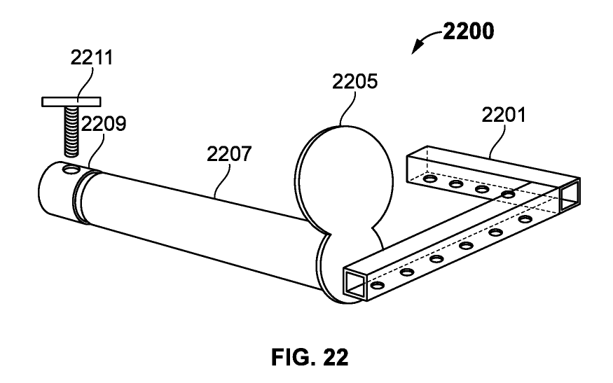

FIG. 22 illustrates an adjustable rotational chainsaw bracket 2200 which may include a support structure 2201 which may be a hollow rectangular tube and which may be L-shaped and which may include a multitude of apertures 2203 which may be bungee hook holes. The support structure 2201 may be connected to a support plate 2205 to engage the side of the chainsaw cover and the support plate 2205 may be connected to a connecting shaft 2207 which may be a hollow tube and engages the chainsaw bracket receiver 2209 and may be fastened to the bracket receiver 2209 and by a fastener 2211 which may be a threaded bolt.

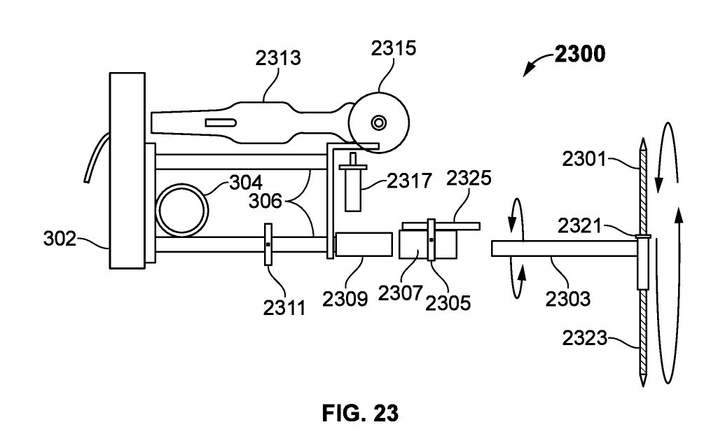

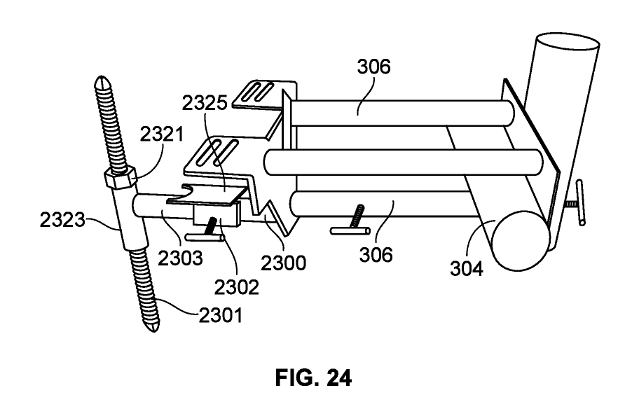

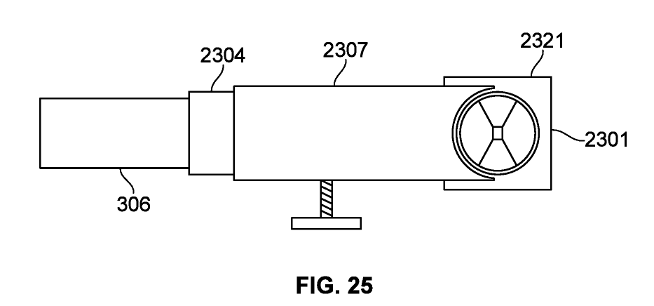

FIGS. 23-25 illustrate a side view, perspective view and top view respectively of a dual angle grinder bracket 2300 which may include a threaded rod 2301 which may use to mount lumber and which may rotate in order to present the lumber at different positions. The threaded rod 2301 may be connected to a threaded fastener 2321 to connect to a threaded shaft 2323 which may be connected to a sliding shaft 2303 which may connect to a a plate 2325 which may include a slot to engage the threaded shaft 2323. The sliding shaft 2303 may engage a receiving shaft 2304.

FIG. 23 additionally illustrates the grinder 2313 connected to a grinder blade 2315.

Although the invention has been explained in relation to its preferred embodiment, it is to be understood that many other possible modifications and variations can be made without departing from the spirit and scope of the invention.

1) A woodworking jig to hold lumber, comprising:
a central column;
a chainsaw support assembly to slidably connected to the central column;
an angle grinder support assembly to slidably connect to the central column; and
a vertical log support to support the lumber positioned alongside of the central column.

2) A woodworking jig to hold lumber as in claim 1, wherein the woodworking jig includes a sleeve clamp slidably positioned on the central column.

3) A woodworking jig to hold lumber as in claim 1, wherein the chainsaw support assembly includes a vertical chainsaw shaft collar.

4) A woodworking jig to hold lumber as in claim 1, wherein the chainsaw support assembly includes a horizontal chainsaw shaft collar.

5) A woodworking jig to hold lumber as in claim 1, wherein the chainsaw support assembly includes a chainsaw connection plate.

6) A woodworking jig to hold lumber as in claim 1, wherein the chainsaw support assembly includes a guide arm.

7) A woodworking jig to hold lumber as in claim 1, wherein the chainsaw support assembly includes an adjustable-length cantilever.

8) A woodworking jig to hold lumber as in claim 1, wherein the angle grinder support assembly includes a vertical grinder shaft collar 302,

9) A woodworking jig to hold lumber as in claim 1, wherein the angle grinder support assembly includes a horizontal grinder shaft collar.

10) A woodworking jig to hold lumber as in claim 1, wherein the angle grinder support assembly includes a grinder support beam.

11) A woodworking jig to hold lumber as in claim 1, wherein the angle grinder support assembly includes an extending grinder boom.
